(19) United States
(12) Patent Application Publication
(10) Pub. No.: US 2012/0047521 A1
(43) Pub. Date: Feb. 23, 2012

(54) ELECTRONIC DEVICE AND DATA COLLECTION METHOD OF THE ELECTRONIC DEVICE

(75) Inventors: CHIH-YUAN HUANG, Tu-Cheng (TW); I-CHIEH LIN, Tu-Cheng (TW)

(73) Assignee: HON HAI PRECISION INDUSTRY CO., LTD., Tu-Cheng (TW)

(21) Appl. No.: 12/965,146

(22) Filed: Dec. 10, 2010

(30) Foreign Application Priority Data
Aug. 17, 2010 (CN) 201010255451.1

(51) Int. Cl. G06F 3/00

(52) U.S. Cl. 719/330

(57) ABSTRACT

A method for data collection using an electronic device operates in a network. The electronic device stores stacks and one of the stacks stores a database and a service agent. The service agent associates objects related to the service agent. The electronic device determines whether the instance identifications associated with the service agent are deleted from a database. If the instance identifications associated with the service agent have been deleted, a Remote Procedure Call protocol command is sent to the service agent. Accordingly, the electronic device can determine the objects detected corresponding to instance identifications stored in the Remote Procedure Call protocol command.

### BACKGROUND

1. Technical Field

Embodiments of the present disclosure relate to data collection, and more particularly to a data collection method and an electronic device thereof.

2. Description of Related Art

A CPE WAN management Protocol (CWMP) is defined as the TR-069 protocol. The TR-069 protocol defines an application layer protocol for remote management of end user devices. The end user devices include data models with a number of objects. Each one of the objects is a parameter set to execute a corresponding function, such as virtual local area network (WLAN). The parameter set includes a number of parameters, such as Port Number, Port Enable and Port Status. When the objects in the data models are not executed, the objects can be deleted. However, the end user devices need to identify which objects are not executed in the data models.

As shown in FIG. 1, a schematic diagram of a commonly used TR-069 protocol, the end user devices may include the TR-069 protocol stacks. The TR-069 protocol stacks are similar to those used by LAN side protocol. The TR-069 protocol stacks can communicate with the others by calling Remote Procedure Call protocol (RPC). For example, one of the TR-069 protocol stacks is the stack 1 for executing object deletion and one of the TR-069 protocol stacks is the stack 2 for executing object storage. If an end user device needs to identify which object is deleted from the stack 2, the stack 1 acquires parameter values from instance identifications of the objects stored in the stack 2 to generate an object list 1. When one of the TR-069 protocol objects stored in the stack 2 is deleted, the stack 2 sends a RPC command to the stack 1. The stack 1 then acquires the parameter values from the instance identifications of the objects stored in the stack 2 again to generate an object list 2. The stack 1 continually compares a difference of the object list 2 with the object list 1 to get the instance identifications of the deleted objects and the corresponding objects detected.

However, backup of instance identification in the stack 2 is required, and a difference between the object list 1 and the object list 2 compared. The procedure wastes memory module space and processing time. What is needed, therefore, is a data collection method that can overcome the limitations described.

### BRIEF DESCRIPTION OF THE DRAWINGS

FIG. 1 is a schematic diagram of a commonly used end user device for data collection.

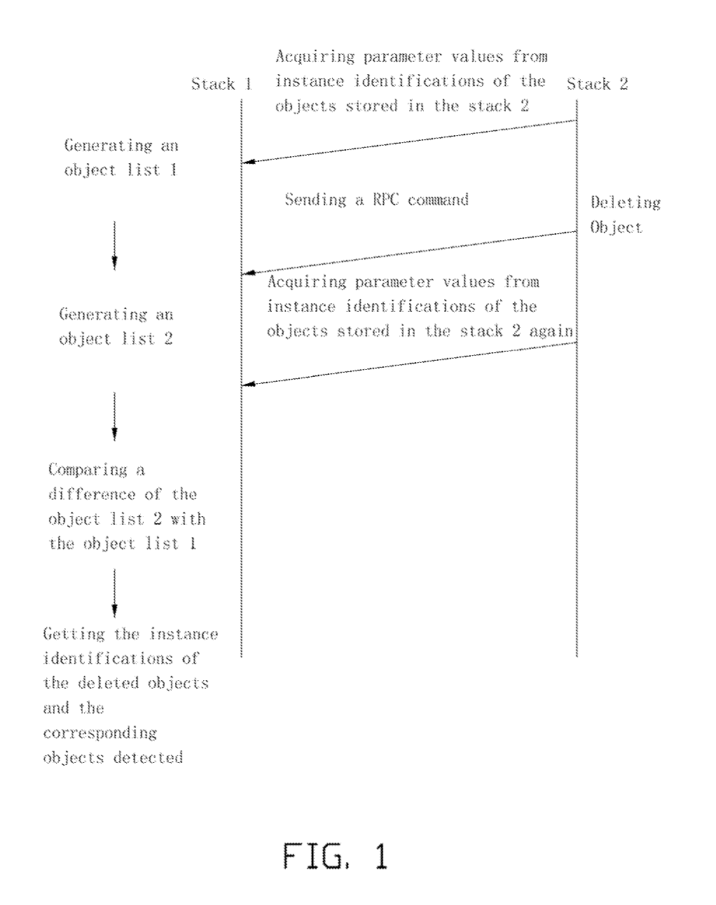

FIG. 2 is a block diagram of one embodiment of an electronic device.

FIG. 3 is a schematic diagram of the electronic device of FIG. 2 operating in a network.

FIG. 4 is a flowchart of one embodiment of a method for data collection using an electronic device.

FIG. 5 shows one exemplary example of a method for data collection using the electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

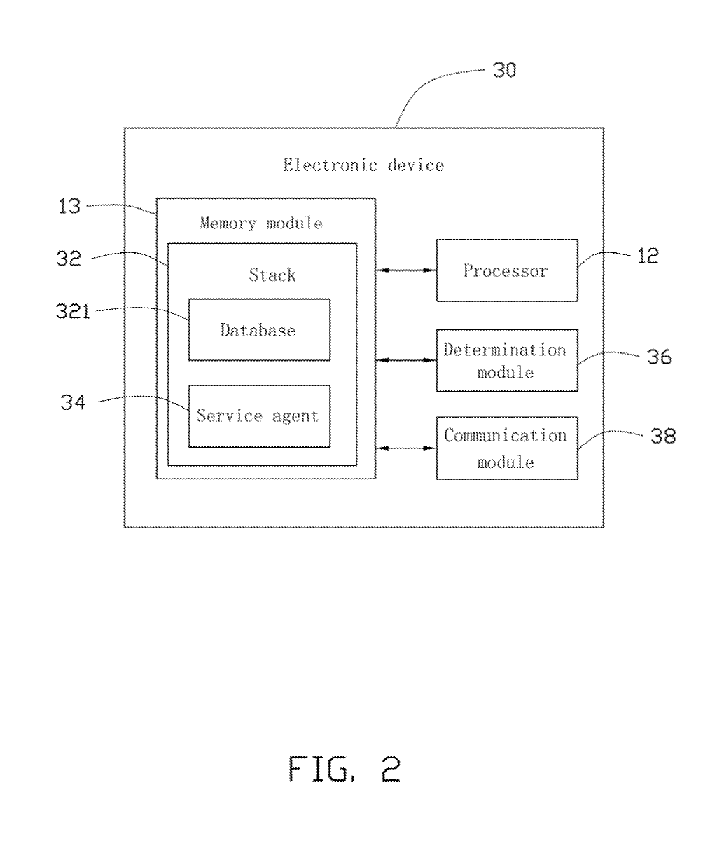

FIG. 2 is a block diagram of one embodiment of an electronic device 30. Depending on the embodiment, the electronic device 30 may be a mobile phone, a personal digital assistant (PDA), a handheld computer, a desktop computer, or other device. The electronic device 30 includes at least one processor 12, a memory module 13, and one or more programs including a determination module 36 and a communication module 38. The memory module 13 stores stacks 32. The stacks 32 can communicate with the others by calling the Remote Procedure Call protocol (RPC) and execute object storage. In one embodiment, one of the stacks 32 stores a database 321 and a service agent 34. In other embodiments, the service agent 34 and the database 321 stored in different stacks 32.

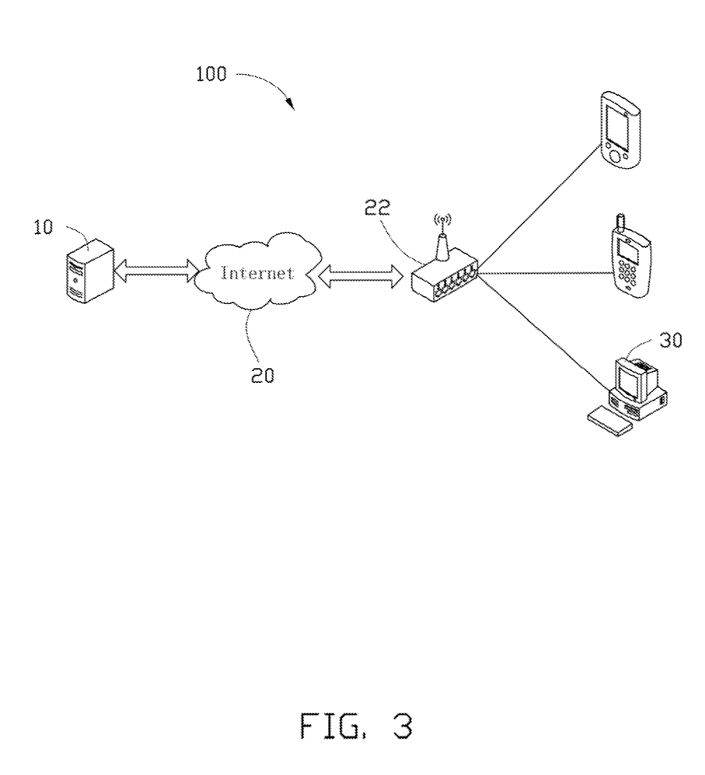

FIG. 3 is a schematic diagram of the electronic device 30 operating in a network 100. The network 100 includes an auto configuration service 10 (ACS), the Internet 20, a gateway 22 and the electronic device 30. The auto configuration service 10 can manage the electronic device 30 by connecting the network 20. The electronic device 30 is a client of the CPE WAN management Protocol (CWMP).

The electronic device 30 is generally controlled and coordinated by an operating system application, such as UNIX, LINUX, WINDOWS, MAC OS X, an embedded operating system, or any other compatible operating systems. In other embodiments, the electronic device 30 may be controlled by a proprietary operating system. Conventional operating systems control and schedule computer processes for execution, perform memory module management, provide file system, networking, and I/O services, and provide a user interface, such as a graphical user interface (GUI), among other things.

The modules 36 and 38 may comprise computerized code in the form of one or more programs that are stored in the memory module 13. The computerized code includes instructions that are executed by the at least one processor 12 to provide functions for modules 36 and 38. The at least one processor 12, as an example, may include a CPU, math coprocessor, shift register, for example.

The memory module 13 is electronically connected to the at least one processor 12, the determination module 36 and the communication module 38. The memory module 13 is operable to store many kinds of data, such as the stacks 32, the database 321, the service agent 34, a customization function code of the electronic device 30, computerized codes of the determination module 36, programs of an operating system and other applications of the electronic device 30. The memory module 13 may include a hard disk drive, flash memory module, RAM, ROM, cache, or external storage mediums.

The stack 32 includes a database 321. The database 321 is operable to store parameter values and instance identifications of objects.

The service agent 34 is operable to associate the objects related to the service agent 34. The service agent 34 is a software agent designed to access services in networks. The service agent 34 can detect the objects corresponding to the instance identifications stored in the database 321. In one embodiment, the service agent 34 and the database 321 are stored in the same stack. In other embodiments, the service agent 34 and the database 321 are stored in different stacks.

The determination module 36 is operable to determine whether the objects in the data models have been deleted. In one embodiment, the determination module 34 determines whether the objects in the data models have been deleted by determining whether the instance identifications of the objects associated with the service agent 34 have been deleted.

The communication module 38 is operable to send a RPC command to the service agent 34 if the determination module 36 determines the objects have been deleted by the instance identifications of the objects have been deleted. The RPC command includes the instance identifications of the objects deleted. The service agent 34 can detect the objects deleted by the instance identifications included in the RPC command.

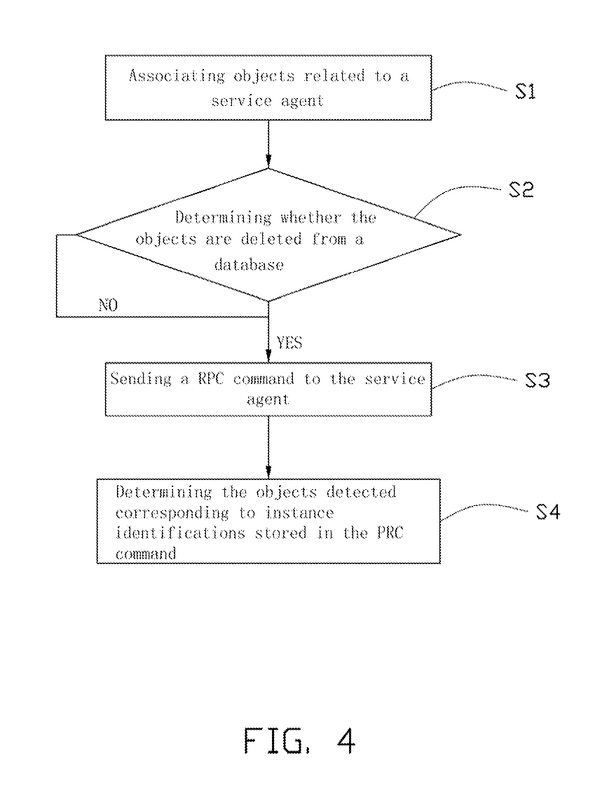

FIG. 4 is a flowchart of one embodiment of a method for data collection using an electronic device 30. Depending on the embodiment, additional blocks may be added, others deleted, and the ordering of the blocks may be changed.

In block S1, the service agent 34 associates objects related to the service agent 34. In one embodiment, after associating the objects related to the service agent 34, the service agent 34 can detect the objects corresponding to the instance identifications transferred from the communication module 38.

In block S2, the determination module 36 determines whether the instance identifications associated with the service agent 34 are deleted from a database 321. If the instance identifications associated with the service agent 34 have been deleted, block S3 is implemented. If not, block S2 is repeated.

In block S3, the communication module 38 sends a RPC command to the service agent 34. The RPC command includes the instance identifications of the objects deleted.

In block S4, the service agent 34 receives the PRC command and determines the objects detected corresponding to instance identifications stored in the PRC command

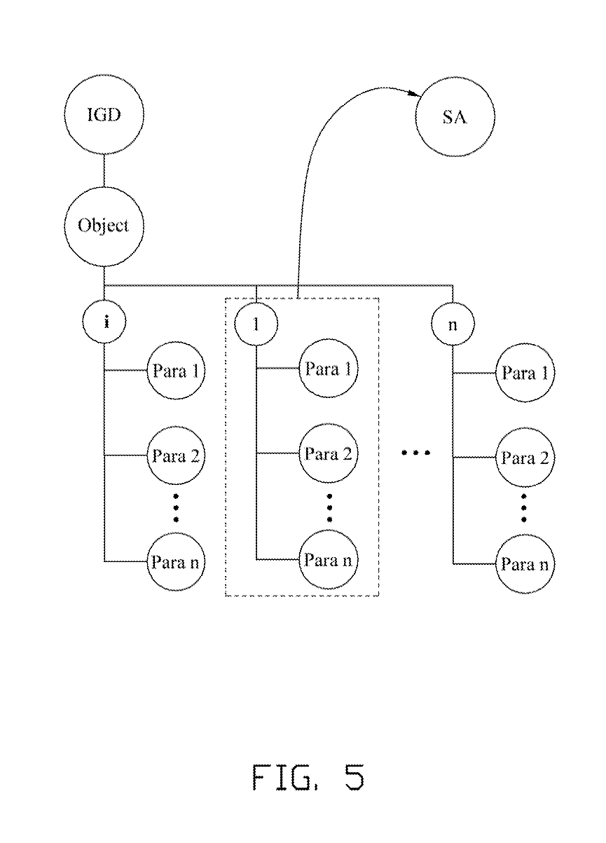

FIG. 5 is one embodiment of a method for data collection using the electronic device 30. As shown in FIG. 5, an IGD is a data model in the electronic device 30. The Object is a set of all objects in the electronic device 30 and the SA is the service agent 34 in the stack 32. The numbers 1-n are identification numbers of the objects. For example, the Object is a set of object 1, object 2, . . . and object n. Each one of the objects has a number of parameters, such as Para 1, Para 2 . . . and Para n. Each one of the parameters has a parameter value.

For example, if the object 1 is deleted, the communication module 38 sends a RPC command to the service agent 34. The RPC command includes the instance identification relative to the object 1. The SA can determine the object 1 detected by the instance identification stored in the PRC command.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a memory module;
at least one processor;
a stack comprising a database operable to store parameter values of objects and instance identifications of the objects;
a service agent operable to detect the objects corresponding to the instance identifications of the objects stored in the database;
one or more programs that are stored in the memory module and are executed by the at least one processor, the one or more programs comprising:
a determination module operable to determine whether the objects have been deleted from the database; and
a communication module operable to send a Remote Procedure Call protocol command to the service agent if the objects have been deleted.

2. The electronic device of claim 1, wherein the RPC command comprises the instance identifications.

3. The electronic device of claim 1, wherein the electronic device is supported for the CPE WAN Management Protocol.

4. The electronic device of claim 1, wherein the service agent and the database are stored in the same stack.

5. The electronic device of claim 1, wherein the service agent and the database are stored in different stacks.

6. A method for data collection using an electronic device in network, the electronic device comprising a service agent, the method comprising:
associating objects related to the service agent to the service agent;
determining whether the objects have been deleted from a database;
sending a RPC command to the service agent if the objects have been deleted; and
receiving the PRC command and determining the objects detected corresponding to instance identifications of the objects stored in the PRC command.

7. The method of claim 6, wherein the step of determining whether the objects are detected is by determining whether the instance identifications of the objects associated with the service agent are deleted from a database.

8. The method of claim 6, wherein the electronic device is supported for the CPE WAN Management Protocol.

9. A storage medium having stored thereon instructions that, when executed by a processor, causes the processor to perform a method for data collection using an electronic device in network, the electronic device comprising a service agent, the method comprising:
associating objects related to the service agent to the service agent;
determining whether the objects have been deleted from a database;
sending a RPC command to the service agent if the objects have been deleted; and
receiving the PRC command and determining the objects detected corresponding to instance identifications of the objects stored in the PRC command.

10. The storage medium of claim 9, wherein the step of determining whether the objects are detected is by determining whether the instance identifications of the objects associated with the service agent are deleted from a database.

11. The storage medium of claim 9, wherein the electronic device is supported for the CPE WAN Management Protocol.
